(19) United States
(12) Patent Application Publication
(10) Pub. No.: US 2008/0284126 A1
(43) Pub. Date: Nov. 20, 2008

(54) ADAPTIVE BRAKE AND SHIFT MECHANISM FOR A BICYCLE

(76) Inventor: STEPHEN T. SMITH, POULSBO, WA (US)

Correspondence Address: JENSEN + PUNTIGAM, P.S., 2033 6th Ave, Suite 1020, SEATTLE, WA, 98121, US

(21) Appl. No.: 11/749,511

(22) Filed: May 16, 2007

(51) Int. Cl. B62K 3/00

(52) U.S. Cl. 280/264; 74/502.2

(57) ABSTRACT

The adaptive system in combination includes a handlebar configured with stub end portions which angle slightly toward each other in the direction of the shoulders of the user. Grip shift members are configured to fit against the palm of the user's hand and mounted at the free ends of the handle bar, the grip shift members including a base portion which mates with an existing gear mechanism on the bicycle for shifting of the bicycle gears. A brake mechanism includes a base member mounted on the ends of the handlebar. The brake mechanism further includes a T-shaped member and two connecting members which are each rotatably mounted to the base member and to the T-shaped handle member.

### TECHNICAL FIELD

This invention relates generally to bicycles, and more specifically to adaptive devices for braking, shifting and steering a bicycle for use by individuals with physical limitations, typically in the hands and arms.

### BACKGROUND OF THE INVENTION

Riding a bicycle is a common activity which is relatively straightforward and comfortable for individuals with little or no physical limitations. However, physical limitations of various kinds will often significantly impact the ability and/or comfort of individuals to ride a bicycle. Examples include hand, particularly the thumb, and arm limitations caused, for instance, by osteoarthritis in the hands and fingers, including the thumbs, or carpal tunnel syndrome, among others. These and other limitations in the hands and arms will limit the ability and/or comfort of an individual to steer and brake the bicycle as well as hand shifting the bicycle.

Accordingly, it is desirable to have certain bicycle mechanisms, in particular the braking and shifting mechanisms, adapted to accommadate a user with physical limitations in their hands and/or arms.

### SUMMARY

Accordingly, an adaptive system is provided for a bicycle, comprising one or more of the following assemblies in combination; a handlebar having a center collar portion, intermediate portions which extend from the center collar portion and stub portions which extend from the free ends of the angled portions and angle toward a user on the bicycle; a grip shifter member comprising a rounded grip member configured to fit against the palm of the user's hand, the grip having a base structure which mates with an existing mechanism to shift gears on the bicycle by rotation of the grip member, the grip member being mounted on the ends of the stub portion of the handle bar; and a braking mechanism, mounted in the vicinity of the ends of the stub portions of the handlebar, including a base member attachable to the handlebar ends, a T-shaped handle configured to receive the fingers of a user, and first and second spaced connecting members, each rotatable connected to both the base member and to the T-shaped handle member.

### BRIEF DESCRIPTION OF THE DRAWINGS

FIG. 1 shows a bicycle with adaptive handlebar, shifter and braking mechanisms.

FIG. 2 is an exploded view of the shifter and brake mechanisms relative to the handlebar.

FIG. 3 is a top view of the bicycle handlebar with which the shifter and the brake mechanism are used.

FIGS. 4 and 4A are perspective and cross-sectional views of the shifter mechanism.

FIGS. 5 and 5A are elevational views showing the action of the braking mechanism in use.

FIG. 6 is an exploded view of the braking mechanism.

### BEST MODE FOR CARRYING OUT THE INVENTION

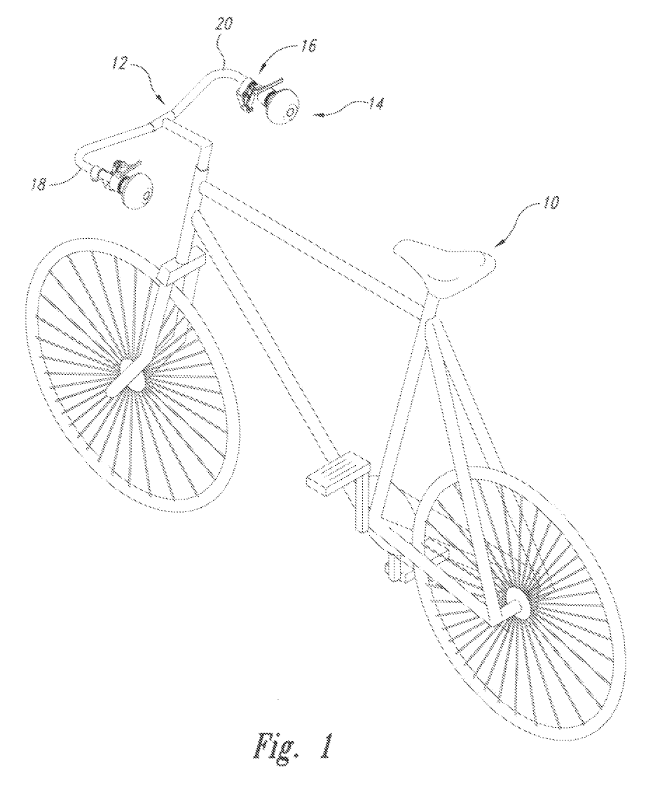

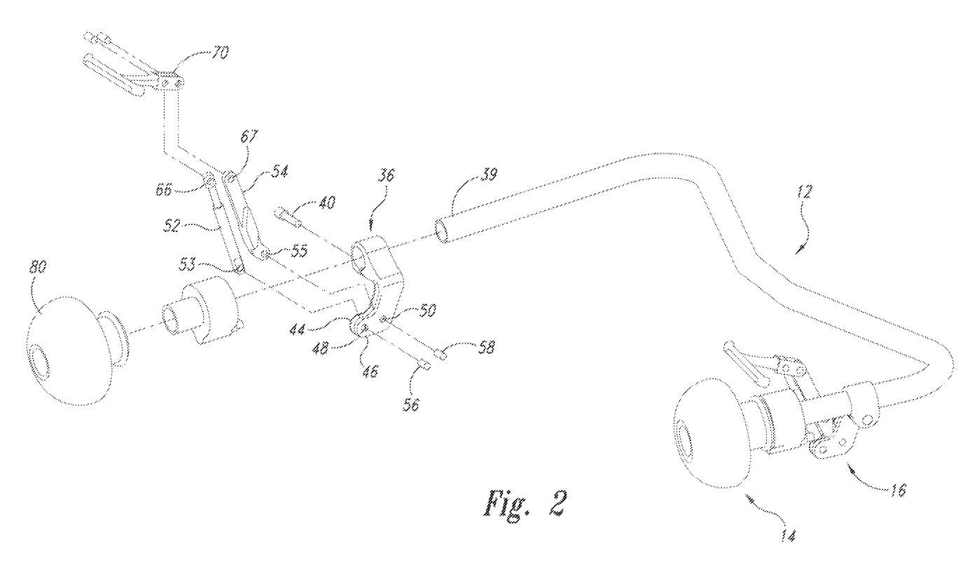

FIG. 1 shows a conventional bicycle 10 with several adaptive-type mechanisms designed to aid individual users who have physical limitations, particularly in their arms and hands. These adaptive mechanisms include a handlebar 12, a gear shift/steering member 14 and a braking mechanism 16. The gearshift/steering member and the braking mechanism are positioned at or in the vicinity of the free ends of handlebar 12. Handlebar 12 is in the general shape of an “M” in a bent tube embodiment or a wide “U” shape in welded or molded tube embodiments, with end portions or stubs 18 and 20 thereof angling slightly inwardly, toward the user.

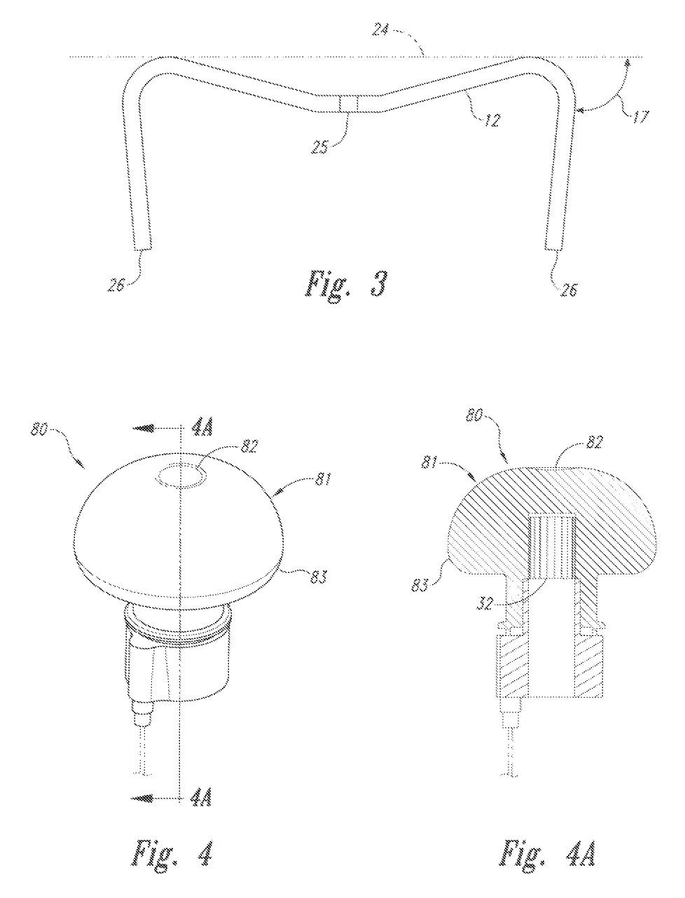

In particular, in the embodiment shown, referring to FIG. 3, the angle 17 of the handlebar end portions is approximately 97° from a straight line 24 (or 7° from a line at a right angle to line 24) drawn across the front end of the handlebars, although this angle can vary over a range of 5°. In the embodiment shown, there is a distance of approximately 9 inches from line 24 to the free ends 26 of stub portions 18 and 20. The width of the handlebars at the widest point thereof is approximately 24 inches, although this can be varied as well. The free ends of the handlebars are separated by a distance in the range of 22-26 inches. The distance from line 24 to the midpoint collar 25 of the handlebars is approximately 6 inches, in the embodiment shown, with the handlebar angling outwardly there from at approximately a 45° angle. In the embodiment shown, the handlebar is made from steel tubing or similar material, approximately ⅞-inch in diameter.

A handlebar with this configuration is generally referred to as an acute offset handlebar. The advantage of this arrangement is that it angles the ends of the handlebar toward the shoulders of the user, such that the user will use mainly the large muscles of the shoulders and arms, as opposed to the smaller muscles of the hands and arms to accomplish the bicycle functions of braking and shifting, as well as conveniently steering the bicycle with the mechanisms described herein.

Shift/steering members 80 are positioned at the free ends 26 of the handlebar. The shift/steering member 80 is shown in more detail in FIGS. 4-4A. Shift/steering member 80 includes a generally mushroom-shaped element 81. Mushroom-shaped element 81 includes a base portion with a number of spline elements 32 which are designed to mate with a conventional derailleur twist-shift shifting mechanism, already present on the bicycle. The original user-operated shift grip device is removed, replaced by the shift/steering member 80.

In the embodiment shown,the mushroom-shaped element 81 is approximately 4 inches in diameter at its greatest point. The element has a center portion 32, at which, in the embodiment shown, there is slight depression 82 with a diameter of approximately 1⅛ inches. The shift/steering member 80 has several advantages. The large mushroom-shaped element itself distributes the loading forces over the area of the palms of the user, as the user presses his/her palms against the surface of the element, with the fingers curved around the outer edge 83 thereof. Twisting the element 81 about its central axis, which is coincident with the central axis of the handlebar stub portions, results in a gear change. The slight depression 82 at the center of the element reduces the force loads on the carpal tunnel portion of a user's hand.

In the embodiment shown, the shift members are made from a hard rubber, but they could also be made from other material, including various plastics or plastic covered by a rubber cushion. The shift/steering members permit a user to conveniently steer the bicycle with minimum discomfort, and also provide a shift capability with relatively little load created on the arms and hands of the user, due to the configuration of the shift members, the position thereof relative to the ends of the handlebar and the configuration of the handlebar itself.

In action, the user simply places palms against the outer surface of the mushroom-shaped elements and uses them to either steer the bicycle by a back-and-forth movement, or shift the gears of the bicycle by a twisting action (rotation).

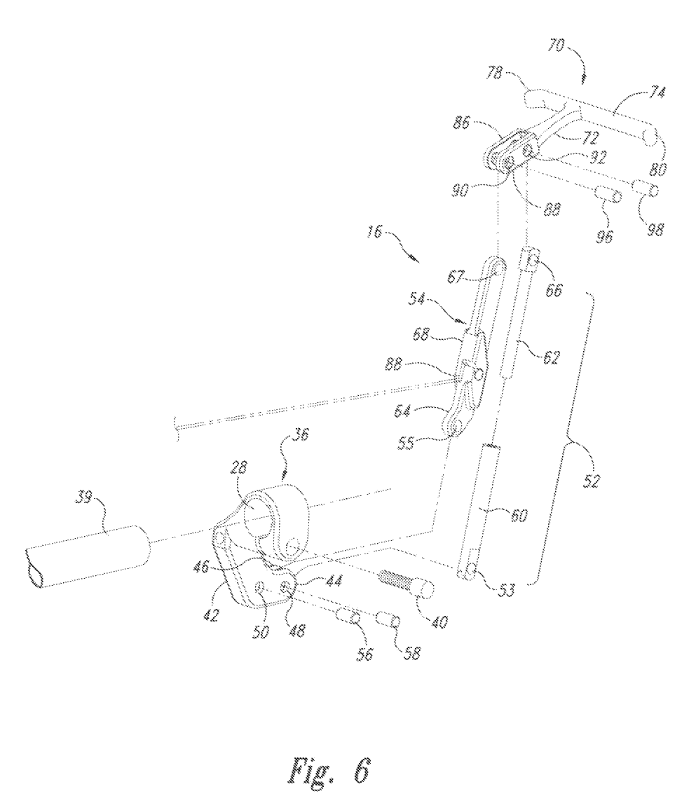

The brake mechanism is shown in FIG. 6. The brake mechanism 16 includes a clamp 36 which includes an opening 28 through which an end portion 39 of the handlebar extends. A screw pin 40 tightens clamp 36 on the handlebar. The clamp 36 includes an extension 42 which includes two ear portions 44 and 46 at the end thereof. Extending through the ear portions 44 and 46 are spaced openings 48 and 50; the openings 48 and ear elements 44 and 46 are in registry, as are openings 50 in ear elements 44 and 46.

Rotatably connected between ear portions 44 and 46 are a turnbuckle member 52 and a dogleg lever element 54. Turnbuckle 52 and lever 54 are rotatably connected to clamp 36 by pins 56 and 58 which extend through openings 48 and 50 in the ear portions 44 and 46 and also through corresponding openings 53 and 55 in one end of the turnbuckle and lever, respectively. Turnbuckle 52 comprises a female part 60 and a male part 62 which is screwed into one end of the female part 60. This arrangement permits the turnbuckle 52 to be adjusted to the desired length. Lever element 54 includes an angled part 64 in the vicinity of one end thereof, referred to as a dogleg, and a thicker region 66 in the remainder thereof. Thicker region 66 includes an opening 88 therein for receiving one end of a brake cable (not shown) which extends to a conventional braking mechanism for a wheel of the bicycle.

The other end of the turnbuckle 52 and the other end of lever 54, which include openings 66 and 67 which are rotatably mounted to a T-handle member 70 of the brake mechanism. The T-handle member 70 includes a base portion 72 and a crossing arm portion 74 at a distal end of the base portion 72. The base portion connects to the crossing arm portion 74 at a point which is approximately ⅓ of the length of the crossing arm portion 74, forming an unbalanced T-handle. The opposing ends 78 and 80 of the crossing arm portion 74 angle outwardly for a short distance away from the user. When the braking mechanism is properly mounted on the handlebar, the base portion of the T-handle member is approximately parallel to the handlebar stub shaft.

The proximal end of base portion 72 includes two parallel ear elements 86 and 88, each having a pair of spaced openings 90 and 92 therethrough. Openings 90 are in registry, as are openings 92. The other ends of turnbuckle 52 and 54 are rotatably secured between ear elements 86 and 88 by pins 96 and 98.

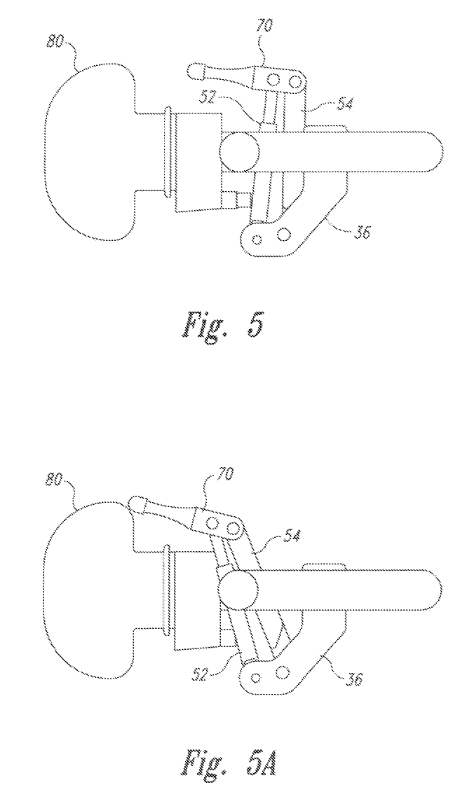

The braking action is accomplished by the finger or fingers of the user gripping the unbalanced T-handle and pulling toward the palms of the hands. The pulling force exerted on the unbalanced T-handle is offset by resulting pressure placed on the palms, preventing discomfort to the user. The unbalanced T-handle configuration is important, since the T-handle must be mounted off-centerline of the handlebar stubs for clearance. Turnbuckle 52 and lever 54, rotatably connected, respectively, at the opposing ends thereof in clamp 36 and the T-handle member 72, form a hybrid parallelogram which results in the T-handle member traveling in a straight line path as opposed to an arcuate one. The position of the T-handle member in its passive/resting position (non-operated) is shown in FIG. 5 and in its operated or activated position in FIG. 5A. The dogleg part of the lever 54 permits compression of the mechanical action of the hybrid parallelogram while the adjustable turnbuckle permits adjustment for different finger sizes. The braking mechanism results in minimal load on the hands and arms of the user and permits a user having such physical limitations to safely and adequately brake the bicycle, with less discomfort than with conventional systems.

The handlebars, the shift member and the braking mechanism can be used in combination on a bicycle to provide compensation/relief for physically impaired users. The three elements work well in combination to provide convenient steering, shifting and braking functions. However, one or more of the mechanisms can be used separately to improve/reduce loads on particular areas of the body relative to providing particular functional capability.

Although a preferred embodiment of the invention has been disclosed here for the purposes of illustration, it should be understood that various changes, modifications and substitutions may be incorporated in the embodiment without departing from the spirit of the invention, which is defined by the claims which follow.

What is claimed is:

1. A grip shifter assembly for a bicycle, comprising:
a rounded grip member configured to fit against the palm of a user's hand, the grip member having a base structure which is mateable with an existing shift mechanism on the bicycle to shift gears on the bicycle in response to a rotation of the grip member, wherein the grip member has central axis which is substantially coincident with a free end portion of a handlebar for the bicycle when the grip member is operatively mounted on the handlebar.

2. The grip shifter assembly of claim 1, wherein the grip member is mushroom shaped and includes a slight cupped area in a top dead center area of the grip member.

3. The grip shifter assembly of claim 1, wherein the grip member is approximately 4 inches diameter.

4. A handlebar for a bicycle comprising:
a tubular handlebar member having a center collar portion, opposing angled portions which extend outwardly from the ends of the collar portion at an angle in the range of 0-50°, and two stub end portions which extend from the ends of the angled portions toward the user and slightly inwardly, wherein the handlebar is configured such that when mounted operatively on the bicycle, the free ends of the stub end portions point toward the shoulders of the user.

5. The handlebar of claim 4, wherein the distance between the free ends of the stub end portions is in the range of 22-26 inches.

6. The handlebar of claim 4, wherein the stub end portions angle inwardly within a range of 5°-10° relative to a reference line.

7. The handlebar of claim 6, wherein the angle is approximately 7°.

8. The handle bar of claim 4, wherein the stub end portions are approximately 9 inches long.

9. A brake mechanism for a bicycle, adapted to receive a brake cable connected to a wheel brake for the bicycle, comprising;
a base member, attachable to a handlebar of a bicycle;
a T-shaped handle, comprising an base piece and a crosspiece located at one end of the base piece configured to receive a finger or fingers of a user;
a first connecting member rotatably connected to both the base piece of the T-shaped member and the base member: and
a second connecting member rotatably connected to both the base piece of the T-shaped member and the base member, such that a pulling action on the T-shaped handle results in a braking action for the bicycle.

10. The brake mechanism of claim 9, wherein the T-shaped handle has as unbalanced configuration.

11. The brake mechanism of claim 9, wherein the first and second connecting members are spaced apart from each other, forming a hybrid parallelogram with the base member and the base piece of the T-shaped member.

12. The brake mechanism of claim 10, wherein the first connecting member is adjustable in length.

13. The brake mechanism of claim 11, wherein the first connecting member is separate from the second connecting member by a distance approximately 25% greater at the base member than at the base piece of the T-shaped handle member.

14. The brake mechanism of claim 13, wherein the brake cable is connected to the second connecting member.

15. An adaptive system for bicycles, comprising:
a handlebar having a center collar portion, intermediate portions which extend from the center collar portion and stub portions which extend from the free ends of the angled portions and angle toward a user on the bicycle;
a grip shifter member comprising a rounded grip member configured to fit against the palm of the user's hand, the grip having a base structure which mates with an existing mechanism to shift gears on the bicycle by rotation of the grip member, the grip member being mounted on the ends of the stub portion of the handle bar; and
a braking mechanism, mounted in the vicinity of the ends of the stub portions of the handlebar, including a base member attachable to the handlebar ends, a T-shaped handle configured to receive the fingers of a user, and first and second spaced connecting member, each rotatably connected to both the base member and to the T-shaped handle member.
